(19) United States
(12) Patent Application Publication
(10) Pub. No.: US 2015/0269593 A1
(43) Pub. Date: Sep. 24, 2015

(54) Product Authentication System

(71) Applicant: Thao Le, Columbia, MO (US)

(72) Inventor: Thao Le, Columbia, MO (US)

(21) Appl. No.: 14/663,361

(22) Filed: Mar. 19, 2015

Related U.S. Application Data
(60) Provisional application No. 61/955,662, filed on Mar. 19, 2014.

(51) Int. Cl. G06Q 30/00; G06Q 50/22; G06Q 10/08

(52) U.S. Cl. CPC G06Q 30/0185; G06Q 10/087; G06Q 50/22

(57) ABSTRACT

A software enabled system employable for medical or other product authentication is provided. The system enabled by software running on a computer with electronic memory and connected databases is adapted for users having a local computing device to input captured product characteristic information which is compared with authenticating characteristics in databases to generate an authenticity rating for each product. Such captured product characteristics may include, for instance, digital photos, keyboard input, voice input, or digital values generated from computer engaged sensors for weight, color, density, or other discernable product characteristics which may be digitally uploaded and employed in a comparison to known authenticating characteristics. Certain product characteristics may be more heavily rated in deriving each authenticity rating which is communicated to the user.

### FIELD OF THE INVENTION

This application claims the benefit of U.S. Provisional Application No. 61/955662 filed on Mar. 19, 2014, and is incorporated in its entirety by this reference.

The present device relates to medical devices and medications. More particularly, the disclosed device and method, relates to a computer enabled software directed system configured to analyze collected data concerning products such as medical products, and employ such collected data to ascertain product integrity and authenticity and additionally to discern real time data concerning possible counterfeiting. By comparing user-garnered data communicated from a network engaged computing device, with product information stored in a relational database, and employing various algorithms of image processing, lookup, and weighted means for comparison, a user can employ the system to ascertain products, particularly over the counter and prescription medications, are authentic.

### BACKGROUND OF THE INVENTION

Counterfeiting of products has become an increasingly severe problem throughout the world. With regard to medical products, counterfeiting can have health as well as life and death consequences. As medical product verification is an important step in proper pharmaceutical treatment, patients, doctors, pharmacists and EMTs often compare medicines against physical or electronic copies of such medical databases as the Physician's Desk Reference (PDR), which provide pictures and descriptions for a user to employ to help characterize an authentic medication.

Pill and medication identification through printed or displayed images is often very difficult due to user inexperience or inability to spot characteristics of counterfeit medications. Suggestions for counterfeiting measures to become more and more effective, such as those of U.S. Pat. Nos. 5,845,264 or 6,543,692 suggest that bar codes, symbols, or chips might be embedded within each unit of medicine for quick verification. However, such is both expensive and in some cases easily subsequently counterfeited.

Additional problems occur when using conventional “lookup” relational databases concerning authentic and counterfeit medical and other products. Data must be communicated concerning the product in question. However, receiving an answer as to a product's authenticity can be very time consuming for both the computing and network system, as well as the user. Further, if the products reviewed are actually authentic, but stolen, such can be hard to ascertain with the current system for authentication, if at all.

As hurdles in the unification of pill identification, however, have prevented these measures, other patents such as U.S. Patent Publication 2008/0000979 and U.S. Pat. No. 7,218,395 teach mechanical or optic specialty sensors which are able to detect pill shape, but which are neither portable nor ubiquitous.

Additionally, although many manufacturers and distributors of products employ internal databases which compile fraudulent medication location and evidence thereof for their own products when such information becomes available, there exists no central repository for collecting and comparing fraudulent product occurrences to allow manufacturers such as drug companies to ascertain the problem and subsequently take the steps to stop the production and/or distribution of counterfeit medical products and medicines.

Still further, current software applications made available for this purpose currently examine only branded pills (solids). Such applications are unable to authenticate generic brands or products of other dosage forms such as liquid, aerosol, gel, cream, and the like. Additionally, current software enabled systems are unable to discern if the products being authenticated are stolen, even if authentic. Still further, current counterfeit detection systems are not enabled with GPS or other location determination such as by WiFi or cell tower triangulation, whereby geographic trends in stolen or fraudulent goods such as medical products can be ascertained in real time and reported to manufacturers and authorities.

As such, there is an unmet need for a computer-enabled software directed system which enables users to validate the authenticity of products, and in particular medical products they are using or consuming, prescribing, purchasing or distributing. Such a system should be enabled to process a wide variety of collected data quickly, and employ software-directed criteria which relates the most likely physical characteristics of a product to ascertain authenticity or lack thereof and to accelerate results. Further such a system should be able ascertain if authentic products authentic but stolen or have been distributed outside normal trade channels.

Still further, such a system should be enabled to communicate discovered fraud and counterfeit data to a database thereof which may be accessed by pharmaceutical companies to aid their efforts in stemming counterfeit medication production, sales, and distribution. Additional utility may be provided if such a system employs software enabled to geographically track authentic product sales and use for geographic trends, and to also geographically determine locations of high or increasing fraudulent product sales. Such an system should be employable with computing device enabled with software and inputs allowing for the review of one or a plurality of identifying characteristics for such products including pill and container photographs, scent, color, product weight in any dosage or form, indicia type, and employ a variety of current image, and input data processing techniques to provide the user with an authenticity confidence integral, as well as additional medicine and emergency information concerning a product or medication if required.

Still further, additional utility would be yielded by such a system if enabled to authenticate name brands of products such as pills and non pills, as well as generic brands, biosimilar drugs as well as liquid or solid or inhalation powders and which is adapted with software and hardware and processing capabilities for capturing and processing characteristic data therefrom to authenticate products in other forms such as liquid, aerosol, gel, cream, and the like.

The forgoing examples of related art and limitations related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

In accordance with the purposes of the present invention, as embodied and broadly described herein, the present system employs software running on any fixed or portable computing device which is adapted to the task herein described, to transform such ordinary portable computing devices such as mobile phones, tablets, tablets, wearable devices (watches, glasses) and other computing devices, into a powerful authenticity detection system. The system herein disclosed is employable by users, retailers, manufacturers and the like, to identify both authentic and counterfeit products and is especially well adapted to identify such characteristics in medical products. Employing a computing device with input components such as keyboards, microphones for oral input, cameras for photographs, scent detectors, and other computer-engageable input components, the system is capable of authenticating any product for which physical and other relational data is discernable for authenticity. In particular the system herein employing software adapted to this authentication tasking is especially well adapted for the authentication of drugs and medicines, cosmeceuticals, branded and generic products, biosimilar drugs as well as liquid or solid or inhalation powders, and over-the-counter (OTC) drugs and consumer products, and doing so in real time using onboard or network accessible databases and onboard or cloud processing of garnered characteristics of any such product.

Running on one or a plurality of networked computing devices, the software directing operation of the system herein thus provides a means for users, distributors, and prescribers of products such as medications to easily assess the authenticity of such as pharmaceuticals and hygiene products. The disclosed system and method herein is enabled employing software configured to run on a mobile device, be it stationary or portable such as a smart phone or pad computer or wrist computing device.

Running on a computing device, the system enabled by such software is configured to communicate with an online server to garner data or responses to communicated product characteristics, to determine locally, the authenticity of a product, such as medications. For increased utility the system may also employ software enabling the system to discern authentic products which have been stolen, as well as provide other unique and novel functions for the user and manufacturer and seller.

The system herein described and disclosed, enabled by the employment of a set of unique software applications adapted to run on portable, fixed, or networked computer devices, such as smartphones, pads, laptops, wrist computers tablets, wearable devices (watches, glasses) and the like, configures these devices to operate as a powerful identity/authenticity detection system. While current applications are slow due to the mode of authenticating, and are only able to authenticate some branded products, and lack any ability to discern the authenticity of generics, or medicines that are non-solid, the system herein, enables the computing device on which it runs, such as a smartphone or pad computer, to provide local authentication of virtually any drugs and medicine and is easily adapted to other products as well and while described herein in relation primarily to medications and medical products, is not intended to be limited to such overall. The system enabled by software adapted to the task, is additionally able to authenticate cosmeceuticals, branded and generics, biosimilar drugs as well as liquid, solid or inhalation powders, and over-the-counter (OTC) drugs, and can be enabled to authenticate various other consumer products on which authenticity characteristics may be ascertained, stored electronically, and employed in a weighted calculation of authenticity.

Because of the lack of authentication by the current art, the system and method herein, provides a means to solve the counterfeited issues from which consumers and commercial firms suffer from a variety of products. The system is currently especially well adapted for authenticating and trending in the sale of medicines in varying dosages and in various physical forms.

Such medical products can include orals (pills), liquids, inhalationals (powder), transdermal, topical (cream, gel), and suppository medicines. Unlike the current art, medical authentication products which are limited to authentication of only pills and some orally ingested products, the system employing the method herein enables the authentication of the noted wide variety of types and forms of products in a wide variety of configurations of use.

In use, the system can be enabled to provide increasingly swift results by the employment of weighted reviewing of inputted product characteristics through their ascertained respective highest probability to discern authenticity or counterfeit. Such characteristic weighting is accomplished by employment of discernable product characteristics known to most likely show counterfeit or authenticity when examined, which will vary product by product. Such weighting of output results from input characteristics may change over time as a relational database of each respective product characteristic most likely to denote counterfeiting is developed.

As such, in employing the system herein in a particularly preferred mode, it will employ software adapted to first examine the input product characteristics determined as the most likely characteristics for a determination of authenticity. Consequently, system performance is improved if such are discerned and employed in a weighted fashion as it will save computing and network time and speed the answer to the user.

In use, employing software adapted to run on a computing device having a data processor, electronic memory, and operating system, which is configured to electronically communicate with a provider-server over a wired or wireless network, the system herein operates to gather input product characteristic data which may then be compared with stored product characteristic data in relational databases concerning each product, and using matching of input characteristic data to that in the database, calculate a level of authenticity. This level, in a preferred mode of the system, is derived from a set of statistically weighted product characteristic data parameters including for instance product characteristics from a group including size, shape, scoring, font, imprint depth, color, product weight in any dosage or form, scent, and density.

For instance, the employment of a higher calculation value to pill indicia which is imprinted on medications in the authentication calculation is preferable as matching of the indicia in size, depth, and fonts, on counterfeit products has been shown in experimentation to be a more challenging characteristic for counterfeiters to match to authentic manufacturer indicia.

Particularly problematic for counterfeiters has been the employment of incorrect fonts for the imprinted product indicia on the products themselves and packaging. Indicia color also preferably is a product characteristic variable with a higher value as branded, generic, and biosimilar drug manufacturers strive to maintain a particular color, where counterfeiters may not or may not have access to the inks or dyes used by manufacturers. Other product characteristic factors employed in an authentication calculation can be the physical size and shape of the medication or the container, which while easier to superficially replicate can still yield product characteristic input data which when compared to electronically stored such data yields evidence of either authenticity or fraud.

In one preferred mode, disclosed authentication system herein, using software running on one or multiple networked computing devices, performs a matrix analysis which employs a plurality of analysis tools, such as, topographical (vector analysis), and in particular, may employ a transparent overlay of a known valid digital 2D or 3D image of a medication or product, superimposed for comparison over a pill, tablet, container, or other product bearing the indicia in question. This overlay allows the system to employ the indicia as well as the product size to ascertain authenticity since varied indicia size and fonts will mismatch authentic indicia characteristics and their relation to product size.

Using a developed intelli-search database which the service provider for the system herein places in networked communication with subscribing users, in conjunction with the above noted product characteristic parameters, the system in another preferred mode, will collect and store product characteristics from a group currently including size, shape, scoring, indicia, font, imprint depth, color, product weight in any dosage or form, scent, and density as product characteristics related to a large variety of medical, pharmaceutical, cosmeceuticals, branded and generic, biosimilar drugs as well as liquid or solid or inhalation powders and OTC products, in a centralized network-accessible location.

System software running on a local stationary or portable computing device such as a smartphone or tablet computer or pad, or laptop, or wrist or body-engaged computer, in communication with the system-provided database over a network, provides the comparable product characteristics to those input by the local device, which may in addition to operating to make weighted comparisons for authenticity, may learn about products being sold or used from every user search.

In addition to employing a weighted calculation of product authenticity from input product characteristics, the system in a preferred mode will also be enabled to discern authentic products, but which are stolen or grey market goods. Such may be ascertained using various product characteristics which are imparted to authentic products by manufacturers, which mark the product for original manufacture location and authorized distribution area. Ascertaining channels of trade of products being authenticated using markers for such provided by manufacturers which are included or added to other product characteristics concerning product origination is especially helpful to manufacturers to ascertain how their products travel through commerce streams to reach consumers and if genuine authorized products are being sold, or gray market products are reaching consumers from unauthorized sources.

For instance, inputted indicia from products being authenticated including images of imprints, fonts, logos, and slogans may be employed by the software and analyzed against a large volume of data available over the network from the hosted server of the service provider for required authentication similarities. The system may learn with every user-comparison and input, by ascertaining what product characteristic data has been input by each user and their locale which has yielded a non-authentication outcome and storing such for use in future comparisons by future users for a similar medication or product.

The system in a preferred mode may also employ software which learns on every authentication inquiry, based on, or irrespective of the geographic position of users, where certain medicines and products are being used, and the geographic areas such medicines and products are showing up as counterfeit. This data concerning authentic and counterfeit sales is valuable to manufacturers and distributors to more quickly discern trends, and to identify quickly if non authentic, or unauthorized products are being sold such as for instance products manufactured for one country which are being sold in a different country.

Additionally, user product input of product characteristics for an authenticity review may be identified with geographic location identifiers of the authenticity determination during each use. GPS, cellular tower, WiFi, or other geographic location determinations can be appended to input product characteristic data being sent over the network during use by consumers. Using these location identifiers, in combination with the individual products being authenticated, pockets of fraudulent or stolen products can be identified for geographic location in real time for manufacturers and distributors. Further, trending of the sale of authentic products being purchased, by geographic location can also be determined to aid in marketing and sales programs for manufacturers.

In use, the system, using a wired or wireless computer network, can include software adapted to verify, through the network information yielding the pharmacy or doctor or hospital or patient ID, and an identifier of the user through their account profile which will be related to an identifier of the user computer such as a Mac ID, as the authorized user and the actual patient, and their respective authorized prescribed drug(s). In this mode of operation, the system may identify the user account owner and their relationship to the particular patient for whom the drug was prescribed, and other prescribed drug(s) for that same patient. In cases where the user patient might pick up multiple drugs at a pharmacy for several family members, the system herein may categorize and store patient-specific data separately from data concerning drugs or medicines or products simply being picked-up.

An additional feature of the system to collect and to legitimize comments from users and patients concerning an authenticated drug or other product. Using the system herein, and verifying the input is originating from a user having a profile matching a verified patient for the drug, the user may provide input for review thereby rendering input to the manufacturer which is much more valuable and accurate than input from unknown sources, which may be corrupted by those with a financial or other interest in the drug or product succeeding or not. For instance, a drug salesperson or a person only picking up the medication for the patient will not be able to provide review. Whereas, the user whose identification is matched to be the patient for whom the medication was prescribed will be allowed such input.

In another mode of operation of the system herein, using software adapted to the task, the system will intelligently learn from prior product authentications of medicines or products each user has or is taking or where multiple users are inquiring. This may be accomplished by storing respective input product characteristic authentication request data from the users, on the user's computing devices or in a cloud or on a provider's server, in a manner related to each respective user. Subsequently, the system, using the known medications ascertained as being used by the respective user patient and employing the data in the digital database over the network which is adapted with data concerning drug intermixing, the system may automatically cross-check for drug interactions, adverse reactions, contra-indications/cautions for a specific patient. This mode solves the problem of patients buying from multiple pharmacies each of which may have no knowledge of the other vendors and what they may have sold an individual user.

In an additional service provided to users by the system provider, employing software adapted to the task, the provider server will allow subscribing users to employ their computing device to access to the latest issued package insert information for a particular medication. In this fashion, the system using software adapted for drug comparison and interactions, and the stored memory of a user's authenticated medications, and the newest issued information from the manufacturers of the medicines and drugs, the system can discern a medication problem for the user, before it happens, and issue a warning to the user sent over the network to their device.

Employing the scan, photo, keypad, recording, and other input capabilities of the user's computing device on which the system software is adapted to run, the system herein provides an ensemble of tools which enable the user to authenticate and store information concerning their respective medicines, be they prescription, generic, biosimilar drugs or over the counter, in a manner which is secure in electronic memory on their local device or accessible from the provider server, using their password-protected account over the network connection.

Product characteristic data input is accomplished by either taking or procuring a 2D or 3D image of the medication or product, and/or by scanning a code image (barcode, QR code, or other coded identifiers) input using voice through a microphone or keyboard input abilities or using other input components engageable with the user computing device. In the event of hospitalization or an emergency such as an overdose or car accident, the user, or their device, can be enabled to provide information on user-taken medications to physicians, ER doctor, first responders, etc. The system can also enable subscribing family members who share the same account to do the same with permission from other users.

In another mode of operation of the system, which may be employed to provide information to product sellers and manufacturers of the medicines or products, the system herein may have software adapted to provide an ensemble of tools which allow such sellers or manufacturers to access a user's non-secured data stored on the server, concerning each product where product characteristics are submitted, where they can use such data as a cross-check against their manufacturing data (e.g., lot ID, date of manufacturer, other authentic identifiers) to further determine authenticity.

Employing locational software adapted to the task, and GPS signals or cellular triangulation, or WiFi location, or other means for geographic location determination, the system may ascertain and store relevant location and/or geographic tracking information which may be employed for a global statistical analysis and empirical modeling in a fashion, and using software configured to pinpoint an origin for counterfeit products, and/or to forecast the next locale where a counterfeit might show up.

Still further, the system employing software adapted to the task of data collection and analyzing for the purpose, the system may be enabled to collect from user devices inputting product characteristic information, and report potential counterfeit in real-time not only to the inquiring users, but also to manufacturing companies. Such would be especially helpful to users in remote areas and foreign countries where counterfeit goods occur with more frequency.

In addition to the collection of user drug information for possible interactions, the system herein, employing software adapted to the task, can provide real-time alerts to users of drug/product recall information, potential overdose, or potential bad reactions by cross-checking with other drugs the user is taking stored in the database related to their account and/or prompt them to add in other OTC drugs they are taking which might cause an increased risk of an adverse event. For instance, if an over-the-counter drug and a drug being taken will have a bad reaction, a pushed warning can be sent to the user device.

The disclosed device, employing a drug identification application configured with a device application employable for input on the user device which will instruct the user to photograph the product, pill or product label and then to optionally measure and record the product weight be it solid or liquid or other form, and/or input characteristics orally or using other engaged sensing components. The user may include, but is not limited to any member of a list containing patients, doctors, pharmacists, pharmaceutical companies, caregivers and investigators.

The photograph and a weighing process can each be performed directly by the device application, or through external camera or scale accessories. Recorded digitized photographs can then be sent to data storage for future use and/or processed and analyzed by the device enabled software application. The device application then sends the processed product characteristics concerning analyzed digital photographic and weight data to external server storage 18.

Although data storage 14 and processing analysis 16 local to the device application 26 enable fast data recall, reduce transmitted data usage, and allow access to stored drug information without internet or cellular reception, cell phone processing capabilities may require direct transmission of photographs to server storage 18.

The server data analysis 20 may then implement one or more renderings of the raw or compressed photographs using filtering tools in a list containing, but not limited to: contouring, sketching, contrast/sharpness, vivid, emboss and negative 40. Implementing the above filters and comparison, the server data analysis compares the raw or compressed photograph to a pre-analyzed stored picture of an authentic pill of the same medication to create and communicate an authenticity confidence rating 22 based on pill's characteristics including but not limited to: size, shape, scoring, font, imprint depth, color and weight of any form or dosage of the product. The image processing on server data analysis can be performed using any current image processing and analysis tools and product characteristic elements captured or input by a user on their portable computing device concerning the product, including one or a plurality of elements from a group including edge detection, contour detection, area of incongruity, as well as RGB, HSL, HSV and CMYK hue analyses. Authenticity confidence rating 22 weights can additionally be assigned to each of the pill's characteristics to emphasize dissimilarities of distinction.

Additionally, the server data analysis 20 may also create a layered image, which overlays one or more of the filtered images of an authentic pill onto the user generated raw or compressed photographs to display dissimilarities between the pill's geometry. This overlay can be performed by scaling the font to the captured size of the pill or vice versa, or alternatively by providing both images to the user and allowing them to scale and compare.

In analyzing the data concerning products which is communicated, the software running on a computer can work first using identified characteristics of the respective product which are ascertained to be predicative of authentic or counterfeit identification. In this fashion the system can speed up the verification process for each respective product by continually identifying fraudulent characteristics and storing such for each product and subsequently operating the identification software to check these determined characteristics for each respective product first. Such will accelerate the user's results and will over time allow for relational databases to be developed for each respective product to help speed authenticity determination.

Additionally using combinations of data such as 2D or 3D product images as well as bar codes and manufacturer markings for instance, authentic products which are stolen or are grey market goods may be identified. This is information that is vital to both consumers, as well as the sellers of the products.

Still further, in operation, the system may employ locational identifiers for user inquiries. Using GPS or wireless triangulation, the geographic area of each inquiry may be tracked over time. In this fashion, geographic hot spots of fraudulent product sales may be identified, and areas of high sales and low sales for any particular authentic product may be determined and provided to manufacturers and sellers as feedback.

During operation in any mode, for instance in a layover mode, once the product identifier data is communicated to a cloud or server, it is processed as noted above. Subsequently, data is then sent back to the user, whereas the device application displays the authenticity confidence rating 22 as well as the layered image. Further pill information, garnered from the drug authenticity statistics or from preprogrammed data on the storage server, may also be provided to the user through the device application including but not limited to characteristics in a list including: manufacturer, pill use, documented pill side effects, drug class, pregnancy risk, CSA schedule, availability, alternate names, documented abnormalities resulting from fraudulent pills, specific health or warning actions necessary if inauthentic pills were taken.

Once a user compares the product images, they can be prompted to enter user comments and data through the device application 26 with such queries included but not limited to: location purchased, time purchase, date purchased, smell irregularities, additional packaging images, receipt images. The device application may also garner GPS information to locate the user's home coordinates which it then transmits, along with the user comments and data to append the server data storage, which can or cannot be reprocessed by the server data analysis.

As pharmaceutical drug companies are ultimately tasked with preventing the sale and distribution of black market medications, through novel identification marks and litigation against fraudulent suppliers, it is important that drug company authenticity statistics be both employed and appended by the drug identification application. As such, analyzed server data is sent to the drug company's authenticity statistics, drug companies can update the server data storage with updated drug information and possible fraudulent sources.

The scope of this drug identification application can extend beyond the use of pills to confirm the validity of a range of medical products including but not limited to: drug labels, boxes, cartons, vials, bottles, cartons, patches, syringes, first aid supplies, herbal medications, hygiene and beauty products. Pictures of labels can also be analyzed to confirm product validity by comparing one or more of the visual characteristics including but not limited to: font, font size, font spacing, bar code, QR codes, box folding patterns, icons, icon spacing.

Product weight information for any dosage or form of the product be it solid or liquid or otherwise, can be garnered through available touch screen weighing applications, or other input devices for weighing the product. For example, a sample pill may be placed on the touchscreen surface of the user device, or the container for liquid. As stated before, an external scale whose output is manually or automatically input to the device application may be implemented for users without touchscreen devices or if a large sample of pills must be weighed.

With respect to the above description, before explaining at least one preferred embodiment of the herein disclosed invention in detail, it is to be understood that the invention is not limited in its application to the details of construction and to the arrangement of the components in the following description or illustrated in the drawings. The device herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other mobile fraudulent pill detection applications for carrying out the several purposes of the present disclosed device. It is important, therefore, that the claims be regarded as including such equivalent construction and methodology insofar as they do not depart from the spirit and scope of the present invention.

It is an object of the present invention to allow a user to ascertain whether a product such as a medical product or drug or over the counter product is authentic or fraudulent by employing a mobile application running on a portable computing device.

It is another object of the present invention to ascertain geographic sales information and provide garnered fraud data to medical sales companies to aid in their black market thwarting campaigns.

It is a further object of the invention to employ a system where product characteristics which determine highest probability to provide an authentication determination are processed first, to thereby save on network and computer time.

It is another object of the invention to employ such a system which geographically tracks individual inquiries and responses to thereby track pockets of fraudulent or stolen product sales.

These and other objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed device. It is intended that the embodiments and figures disclosed herein are to be considered illustrative of the invention herein, rather than limiting in any fashion. In the drawings:

FIG. 1 displays a schematic diagram of product authentication based upon discernable input product characteristics.

FIG. 1A depicts an example of a product authenticity calculation using digital values from input product characteristics compared to a database of such characteristics for each product.

FIG. 2 shows an example of an image processing analysis of an image of a pill form of a product.

FIG. 3 depicts a final processed image analysis using an overlaid area of indicia shown as text font.

FIG. 4 depicts an example of a product label with product which can be analyzed for authenticity based on the product characteristics communicated and relating thereto.

FIG. 5 depicts a mode of the system using a scale to ascertain a weight of a pill form of the product using a smartphone with a touch screen and having software thereon configured to access a weight from pressure exerted on the touch screen.

FIG. 6 depicts a computing device having an input component engaged for sensing smell or other product characteristics such engageable input sensors may capture.

FIG. 7 shows a depiction of a pill medication image in a captured product characteristic on a computing device having a camera and display and having a microphone for oral input of product characteristics.

FIG. 8 depicts an onboard camera on a typical computing device such as a smartphone or pad computer.

FIG. 9 depicts a computing device having a keyboard for user input of comment and/or observed product characteristics.

### DETAILED DESCRIPTION OF THE INVENTION

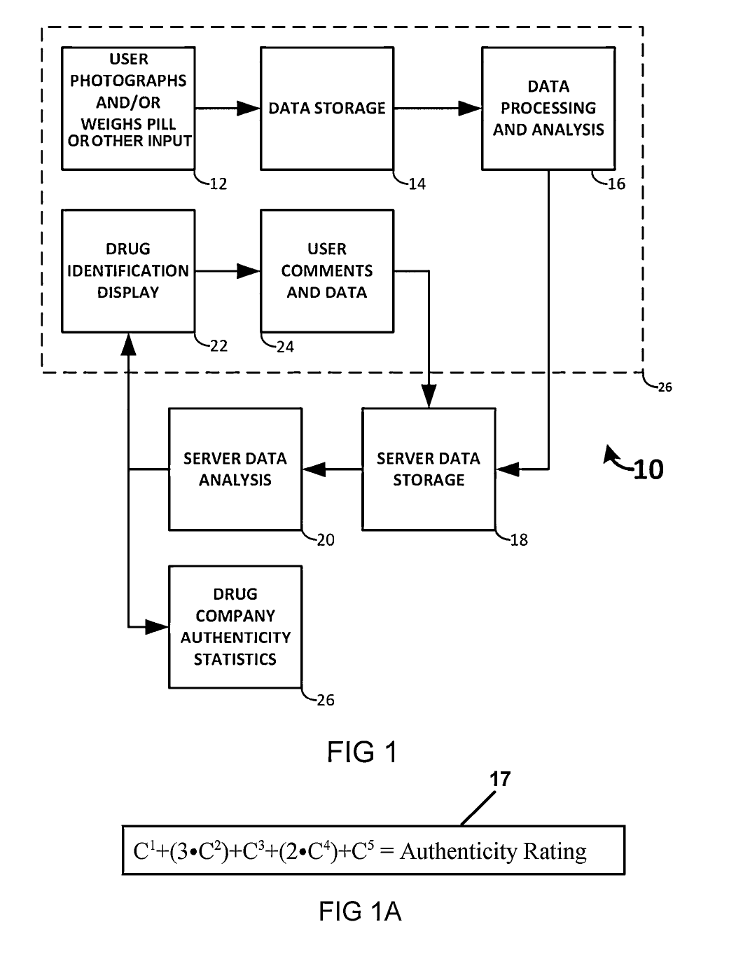

Now referring to drawings in FIGS. 1-9, wherein similar components are identified by like reference numerals, there is seen in FIG. 1, the product authentication system which herein is for ease of description described as a medical product authentication application 10, employs a computer enabled software application 26 configured to run on a computing device such as a mobile device 46 which can include a tablet computer, a laptop computer, a smartphone, and which may also provide display screens to instruct the user on procedure.

As part of the data capturing of product characteristics 12 process, such communicated displays can include instructions to initially obtaining a 2D or in some cases 3D digital image of the product, the pill or a label of the product, or the package or the medication. In other modes the user may optionally measure and record the weight of any dosage or form of a product, as part of the data capturing of product characteristics 12 of the medicine or product and input such using a keyboard or orally, or use other parameters for comparisons. Anticipated users of the device and method herein when authenticating medical products, may include, but are not limited to, any of a group of users including patients, doctors, pharmacists, pharmaceutical companies, care-givers and investigators.

The analysis 16 or calculation 17 (FIG. 1A) of an authenticity confidence rating 22 based on captured product characteristics and user-input product characteristic data, such a video or a digitized product image, and/or one or a plurality of other derived values for product characteristics which are captured or input by the user using a camera, sensor, keyboard, orally input, or discerned by another input component 49, concerning the product in question. Such product characteristics which may be captured or uploaded may be one or a combination of such product characteristics from a group of characteristics including package indicia, container indicia, product size, product shape, scoring, font size, font style, imprint depth, product color, product weight, product tag-image, labels size, label shape, weight, density, scent, digital video, a digitized product image; digitized values for said product characteristics captured by or input from a digital camera, digitized values of a said product characteristic from a sensor engaged with a user computing device, user input from a keyboard engaged with said user computing device, or information concerning said product characteristics orally input information to said user computing device or other discernable product characteristics or data points which may be employed and therefor captured in the product characteristics 12 by the user. Such a comparison can each be performed on a server or in a cloud computing device with the resulting authentication results being communicated to the user's electronic device 46.

It should be noted that the product itself can be identified using the product characteristics captured and digitized based on the authenticity score. Indicia on most pills and medical products is coded by the manufacturers to identify the product, its strength or dosage, and in many cases its manufacturing source. Consequently, such can be employed by the system to both identify what the product is purported to be and concurrently whether it is authentic or counterfeit based on the authenticity rating 22 derived using the individual product characteristics in a weighted or unweighted fashion. An example of such a calculation 17 is depicted in FIG. 1A. Although any mathematical calculation or algorithm which will achieve such an identification and/or authenticity rating 22 as would occur to one skilled in the art is anticipated to be within the scope of this patent and included herein. Of course, the weighted product characteristics can be either positively or negatively weighted depending on the outcome of the comparison with the respective database of known authentic characteristics for each.

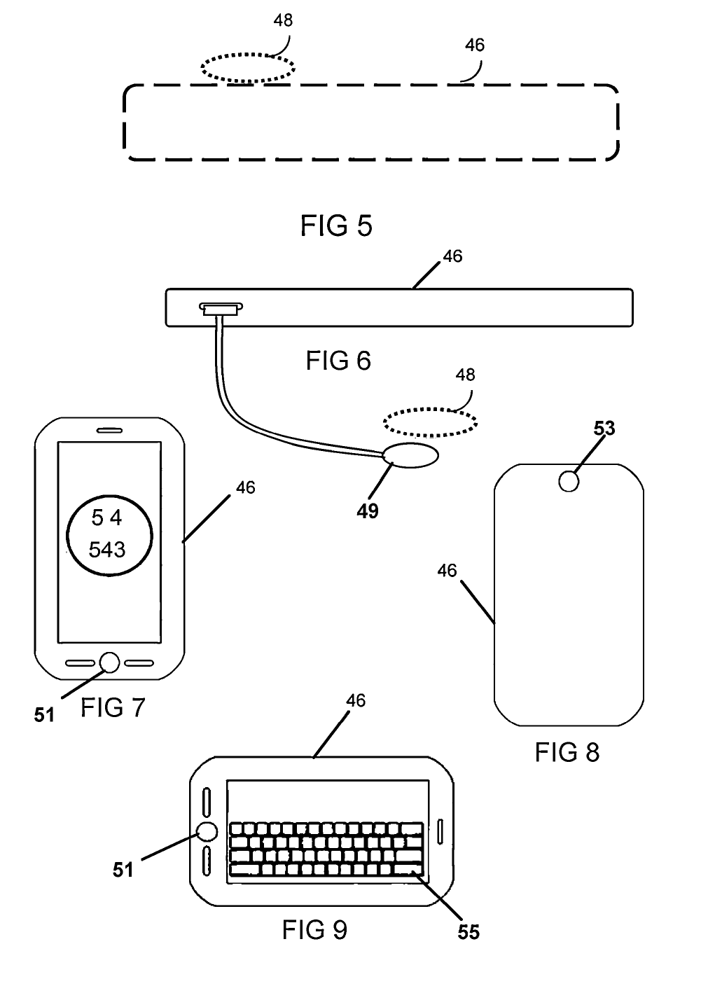

The analysis 16 or calculation 17 using software adapted to conduct it and running on the user device 46, may be performed directly by the user's device 46 using a network connection to relational databases relating to digitized product characteristics in determining both an identification and authenticity of a respective product. Recorded raw or compressed 2D or 3D digital images or photographs 28 or data input by hand, or data orally input concerning product characteristics or sensor-captured product characteristics such as scent, color, weight or density, are captured, input, and processed locally if the phone maintains a local database of digitized authenticity characteristics for a given product, or more likely a cloud-located product data storage 14 in a digital database of individual authentic product characteristics, of each product, using a network connection thereto provided by the user device 46 (FIGS. 5-9). The system allows the user to input the captured or derived product characteristics 12 by providing access to the internet accessible user interface to users to input or capture the product characteristics of each product.

All captured or input product characteristics are digitized whereby once input into the system as a digital file, or digital value, they may be compared to and related with digital files in digital data storage 14 in a database of known authentic product characteristics for each product. The results of this comparison for each product characteristic noted as “C” in FIG. 1A, can then be calculated in a weighted or unweighted calculation to determine product authenticity. Some of these product characteristics, as noted, allow quick identification of the purported product, and may also be used as noted in a weighted fashion to calculate a product authenticity score.

The software is configured to communicate the digitized captured product characteristic data required for the authenticity determination, irrespective of the outcome, over the network such as the Internet or a cell system or the like. Thereafter, analysis done remotely is accomplished and the product characteristic data captured concerning the examined product and locale of the examination is stored on an external server storage in a cloud or on a server 18 which also provides the internet accessible user interface to users for future use in such analysis. It may then be maintained or loaded back as data in onboard memory in local or cloud digital data storage 14 in a digital database of individual authentic product characteristics and other captured data as needed.

Local or cloud data storage 14 or fast network access over a wireless or other network such as the Internet, is employed to retrieve and transmit the comparative data concerning characteristics of authenticity from a databases in a cloud, as well as the captured product characteristic data, to provide such to software adapted to run on the user device 46 or to run the analysis on a remote or cloud computing device. In either location the software configured for the authenticity calculation herein may be adapted to conduct a weighted analysis 16 or calculation 17 of the product in question such as a medicine or other product of interest and which is currently proximate to the user device 46. Such a weighted analysis may also include, for each product being authenticated and maintained in a database of product characteristics most likely to identify a counterfeit based on historical garnered characteristic information and manufacturer provided authentic characteristic information as to such likely attributes. This will speed up processing. Therefore, a characteristic-weighted analysis is preferred since the received characteristic data concerning a product and concerning those attributes will be discerned first, for a result.

Local storage or easy wireless or wired network communication will enable fast data transmission and processing on a server. Using the noted identified likely product characteristic attributes will reduce the need for network transmitted data by first communicating comparative product characteristics predetermined to more easily ascertain authenticity. However, any wired or wireless access to stored drug information, or product information, or other relevant authentication information, which may be digitized and transmitted over the network connection, such as using cellular reception, may be employed.

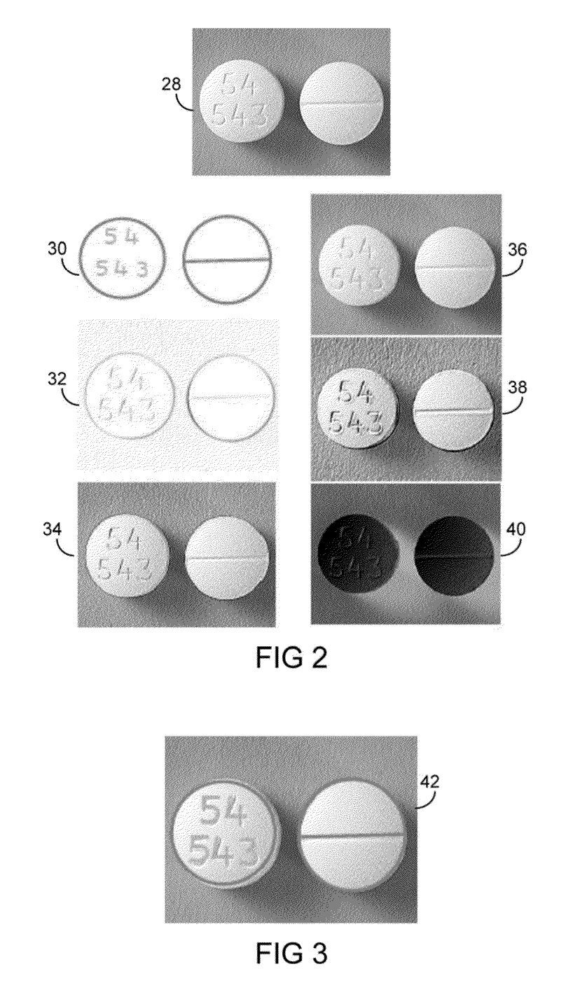

In one verification step, data analysis 20 results can be communicated to the user device display, one or more viewable renderings of the images or photographs 28 of the product being discerned. Such can also include product characteristics of product labels, bar codes, or various viewpoints of the product, and using filtering software providing one or a combination of contouring 30, sketching 32, contrast/sharpness 34, vivid 36, embossing 38, an overlay image may be provided which is displayed in combination with the product image. The overlay image communicated by display as a negative 40 as seen in FIG. 2 or in another fashion, which in combination with the captured product image on the same display, allows the user, or image processing software, to perform a comparative overlay to verify the product characteristics of the overlay image, matches that of the product characteristics of the captured image of the product. If the product is frequently purchased by the user this overlay depiction of the authentic product characteristics may be stored locally on the user's device for subsequent overlay in combination with the product when purchased in the future for an instant comparison.

While the overlay noted is a particular favorite due to the allowance of the user to review the product in question locally, implementing the product review, the system data analysis can compare any provided or captured or user-input product characteristics concerning the product being reviewed which as noted may include one or a combination of characteristics from a group including fonts, logos, known indicia, product size, product or container shape, pill scoring, pill or package font, imprint depth, pill or package color, weight of the product in any form, scent and density. For instance, the indicia or imagery in a digital photograph 28 may be compared with a pre-analyzed imagery or indicia such as fonts stored in computer memory which is a rendering of known authentic characteristic of the product or medicine indicia, such as an authentic pill 48 of the same medication and dosage the user is authenticating, to create an authenticity confidence rating 22, based on data captured on the pill's 48 product characteristics.

In another example, software configured for image processing, or product characteristic comparison of known product characteristics with captured product characteristics 12 using data analysis 20 can be performed using a number of image processing and analysis of known and captured product characteristics including one or a combination of edge detection, contour detection, area of incongruity, as well as RGB, HSL, HSV and CMYK hue analyses. An authenticity confidence rating weighting, based on the different matches and variances from the accepted authentic analysis of product characteristics, can additionally be assigned to each of the pill 48 characteristics, to emphasize dissimilarities of distinction between known authentic product characteristics and captured such characteristics.

Additionally, software running on the user device or on a remote computer or server of the provider, and in communication with the user device 46 and configured for such a data analysis 20 can also create a layered image 42, per FIG. 3, which overlays one or more digitized images of having characteristics of a known authentic pill 48, or product, onto the user captured or input images or photographs 28 of the local product, to thereby allow the user's eyesight, as well as image recognition software, to discern any and all dissimilarities between the imagery of characteristics of the current pill 48 in geometry and/or indicia and/or color and/or other noted image processing derived product characteristics above.

With regard to product indicia, the generated displayed overlay can be performed by a scaling of an image and indicia characteristics of a stored genuine product to overlay upon the captured size of the pill 48 or product or vice versa. Alternatively the system using the network and from stored information in system databases and using software adapted for such, can communicate to the user device 46 an overlay of known product image characteristics for the user and to employ and adjust in scale using software-enabled pixel sizing controls on their user device 46 to achieve an overlay and thereafter visually compare them for decision on authenticity based on the overlain product characteristics of each.

The computer generated overlay or comparison or the user constructed overlay or comparison of such product characteristics, may be employed locally with associated software adapted to employ the noted authenticity characteristics above using image recognition, to provide an authenticity confidence rating 22, concurrently with the user visually review. Alternatively the data analysis 20 comparing known product characteristics in the digital database with captured product characteristics may be networked to a computer having more computing power and running software adapted to use imagery and noted image recognition characteristics, in combination with other captured, input, and discerned product characteristics data, and provide an authenticity calculation, or rating. This may then be communicated back to the user device 46, per FIG. 1, whereas the device application 26 will generate a viewable display of the authenticity confidence rating and can also display a transmitted layered image 42.

Additionally, product and/or medication information such as pill 48 characteristics information, garnered from the drug authenticity statistics 26 or from stored data on a server 28, may also be provided to the user through the device application 26 including but not limited to characteristics of manufacturer, pill use, documented pill side effects, drug class, pregnancy risk, CSA schedule, availability, alternate names, documented abnormalities resulting from fraudulent pills, specific health or warning actions necessary if inauthentic pills 48 were taken.

If user comparison of overlay or similar imagery is employed, once a user compares the product characteristics such as pill 48 images, software running on the system can create a prompt on their device to enter their personal comments and user inputted data 24 through the device application 26 using a keyboard or orally with a device microphone. Such prompted response requests can include a displayed image with fields for input of user comments on one or a combination of comment factors including location purchased, time purchase, date purchased, smell irregularities, additional packaging images, receipt images.

The device application 26 using software adapted to communicate and make a cell tower triangulation or to ascertain a GPS information from components on the user device 46, to thereby locate the user location which is communicated along with the user inputted comments and data 24 for storage and later use on the server data storage on a server 18 also providing the required internet accessible user interface for uploading user characteristics and operation of the system.

As pharmaceutical drug companies, and other product manufacturers, have the most financial stake in the sale of authentic products tasked with preventing the sale and distribution of black market medications, is important that drug company and other products of companies respective authenticity statistics 26 be both employed and appended by the drug authentication application 10. As noted, data communicated from users may be geographically tagged on each respective occasion. Thereafter, when a counterfeit product, or an authentic product is discerned, geographic hot spots of such incidents may be determined in real time. This will allow for real time determinations of increases and decreases in sales of authentic products as well as counterfeit products. Results of such data analysis 20 may be communicated to manufacturers such as the drug company or other product company for determining their own authenticity statistics 26, and the drug and product manufacturers can update the server data storage on the server 18 or connected data storage 14 with updated drug information and possible fraudulent sources.

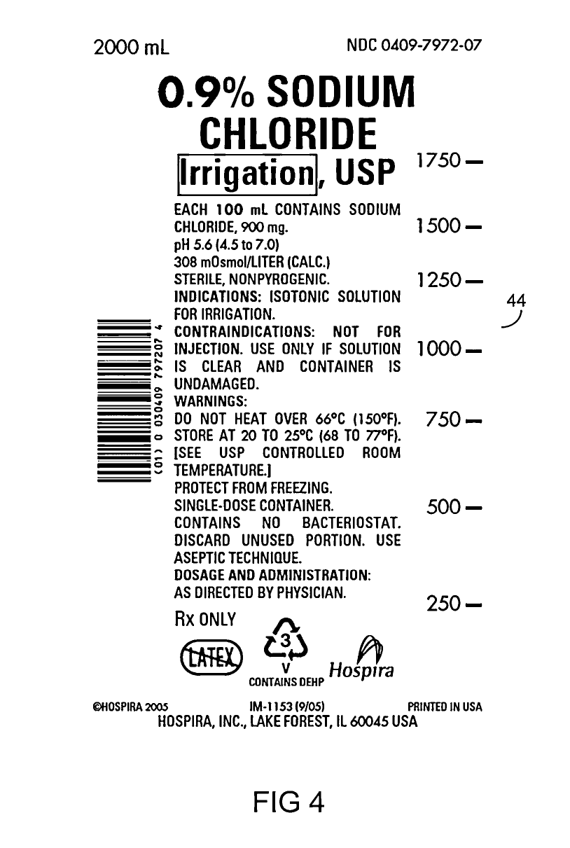

The scope of this product authentication application 10 can extend beyond the use for medical products such as pills 48 to confirm the validity of a range of medical products including but not limited to: drug labels, boxes, cartons, vials, bottles, cartons, patches, syringes, first aid supplies, herbal medications, hygiene and beauty products, as well as other non medical products which are subject to counterfeiting. Per FIG. 4, a label 44 can be analyzed to confirm product validity by overlaying or employing photo authentication software comparing one or more of the visual product characteristics including but not limited to: font, font size, font spacing, bar codes, QR codes, box folding patterns, icons, icon spacing, colors, indicia, containers size and shape, and any other visually discernible aspect which may be compared in a digital depiction or using digital recognition software in a comparison of known authentic products and captured video of a currently reviewed product.

As shown in FIG. 5, in addition to the visually discernable product characteristic aspects of products, packaging or product or pill weight information, can be captured through available touch screen weighing applications, or input manually on the keyboard or orally using voice, whereas for example, a sample pill 48 is placed on the touchscreen surface of the user device 46. As stated before, an external scale whose output is manually, orally, or automatically input to the device application 26 may be implemented for users without touchscreen devices or if a large sample of pills 48 or product or package must be weighed.

FIG. 6 depicts a computing device 46 having an input component 49 operatively engaged for sensing product characteristics which are discernable by such input components 49 such as smell, or color, or sonic reflections for density, or other product characteristics such engageable input components 49 may now or in the future capture. Such input components 49 continue to evolve and all are intended within the scope of this patent and the claims herein.

FIG. 7 shows a depiction of a pill medication image being captured on a computing device 46 having a camera 53 and display and having a microphone 51 for oral input of product characteristics. As can be seen, the image contains indicia which can be employed as a product characteristic for both identification of the product itself, and a calculation of an authenticity rating.

FIG. 8 depicts an onboard camera 53 on a typical computing device 46 such as a smartphone or pad computer. Also shown in FIG. 9 is a mode of such a computing device 46 having a keyboard 55 for user input of comment and/or observed product characteristics by the user manually if the user is so directed or so inclined.

As noted, any of the different configurations and components can be employed with any other configuration or component shown and described herein. Additionally, while the present invention has been described herein with reference to particular embodiments thereof and steps in the method of production, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A software enabled product authentication method comprising:
providing an internet accessible user interface on a host computing device in communication with one or more digital storage devices configured for storing a digital database of authentic product characteristics of each said product;
providing access to the internet accessible user interface to users to input captured said product characteristics of a said product;
running a comparison of said captured product characteristics input by said user to said authentic product characteristics in said digital database;
generating an authenticity rating for said product based upon said comparison; and
communicating said authenticity rating to said user.

2. The software enabled product authentication method of claim 1, additionally comprising:
running said comparison of said captured product characteristics using a plurality of said captured product characteristics communicated from said user;
calculating a respective product value of each said product characteristic derived from a respective said comparison of each respective said product characteristic to a respective said authentic product characteristic;
deriving a weighted value for at least one said value of a respective product characteristic in a said comparison with a respective said authentic product characteristic known to be an accurate predictor of authenticity; and
employing said product values calculated for said product characteristics and said weighted value in generating said authenticity rating.

3. The software enabled product authentication method of claim 1 wherein said captured product characteristics include one or a plurality of product characteristics from a group including, package indicia, container indicia, product size, product shape, scoring, font size, font style, imprint depth, product color, product weight, product tag-image, labels size, label shape, weight, density, scent, digital video, a digitized product image; digitized values for said product characteristics captured by or input from a digital camera, digitized values of a said product characteristic from a sensor engaged with a user computing device, user input from a keyboard engaged with said user computing device, or information concerning said product characteristics orally input information to said user computing device.

4. The software enabled product authentication method of claim 2 wherein said captured product characteristics include one or a plurality of product characteristics from a group including, package indicia, container indicia, product size, product shape, scoring, font size, font style, imprint depth, product color, product weight, product tag-image, labels size, label shape, weight, density, scent, digital video, a digitized product image; digitized values for said product characteristics captured by or input from a digital camera, digitized values of a said product characteristic from a sensor engaged with a user computing device, user input from a keyboard engaged with said user computing device, or information concerning said product characteristics orally input information to said user computing device.

5. The software enabled product authentication method of claim 1 wherein said comparison of said captured product characteristics input by said user to said authentic product characteristics in said digital database includes:
communicating a digital image of an authenticated said product from said digital database of authentic product characteristics;
positioning said digital image overlay upon a captured product image upon a display viewable by said user; and
allowing said user to compare similarities of said digital image and said captured product image in determining said authenticity rating.

6. The software enabled product authentication method of claim 3 wherein said comparison of said captured product characteristics input by said user to said authentic product characteristics in said digital database includes:
communicating a digital image of an authenticated said product from said digital database of authentic product characteristics;
positioning said digital image overlay upon a captured product image upon a display viewable by said user; and
allowing said user to compare similarities of said digital image and said captured product image in determining said authenticity rating.

7. The software enabled product authentication method of claim 1 additionally comprising:
ascertaining a geographic location for each said user;
storing said authenticity rating for a respective individual product which is communicated to multiple users in said digital database; and
communicating said stored authenticity ratings to manufacturers of said products related to respective individual said geographic locations of respective users whereby said manufacturers may determine sales of authentic and counterfeit said products by said geographic location.

8. The software enabled product authentication method of claim 4 additionally comprising:
ascertaining a geographic location for each said user;
storing said authenticity rating for a respective individual product which is communicated to multiple users in said digital database; and
communicating said stored authenticity ratings to manufacturers of said products related to respective individual said geographic locations of respective users whereby said manufacturers may determine sales of authentic and counterfeit said products by said geographic location.

9. The software enabled product authentication method of claim 6 additionally comprising:
ascertaining a geographic location for each said user;
storing said authenticity rating for a respective individual product which is communicated to multiple users in said digital database; and
communicating said stored authenticity ratings to manufacturers of said products related to respective individual said geographic locations of respective users whereby said manufacturers may determine sales of authentic and counterfeit said products by said geographic location.

10. The software enabled product authentication method of claim 1 wherein said products are drugs, additionally comprising:
for each said product on which a said authenticity rating is derived from said comparison of said captured product characteristics input by a respective user, storing an identification of said product identified by said authenticity rating in said digital database as a purchased said product by said respective user;
each time a subsequent said authenticity rating is derived from a said comparison, examining a said identification of each said subsequent said product to all said purchased said products in said digital database and identifying possible negative interactions between said purchased products; and
communicating to said user a warning of a said negative interaction if found.

11. The software enabled product authentication method of claim 4 wherein said products are drugs, additionally comprising:
for each said product on which a said authenticity rating is derived from said comparison of said captured product characteristics input by a respective user, storing an identification of said product identified by said authenticity rating in said digital database as a purchased said product by said respective user;
each time a subsequent said authenticity rating is derived from a said comparison, examining a said identification of each said subsequent said product to all said purchased said products in said digital database and identifying possible negative interactions between said purchased products; and
communicating to said user a warning of a said negative interaction if found.

12. The software enabled product authentication method of claim 6 wherein said products are drugs, additionally comprising:
for each said product on which a said authenticity rating is derived from said comparison of said captured product characteristics input by a respective user, storing an identification of said product identified by said authenticity rating in said digital database as a purchased said product by said respective user;
each time a subsequent said authenticity rating is derived from a said comparison, examining a said identification of each said subsequent said product to all said purchased said products in said digital database and identifying possible negative interactions between said purchased products; and
communicating to said user a warning of a said negative interaction if found.

13. The software enabled product authentication method of claim 1 wherein said products are drugs, additionally comprising:
for each said product on which a said authenticity rating is derived from said comparison of said captured product characteristics input by a respective user, storing an identification of said product identified by said authenticity rating in said digital database as a purchased said product by said respective user;
allowing said user to input a retailer where each respective said product on which said authenticity rating is derived, was purchased;
storing in said digital database, each said retailer in a relation to each said product on which said authenticity rating is derived;
each time a subsequent said authenticity rating is derived from a said comparison, examining a said identification of each subsequent said product with all said purchased products in said digital database, and identifying possible negative interactions between said purchased products;
communicating to said user a warning of a said negative interaction if found; and
communicating a said warning to a respective said retailer identified by said user as the respective said retailer where said respective product was purchased, of said negative interaction.

14. The software enabled product authentication method of claim 5 wherein said products are drugs, additionally comprising:
for each said product on which a said authenticity rating is derived from said comparison of said captured product characteristics input by a respective user, storing an identification of said product identified by said authenticity rating in said digital database as a purchased said product by said respective user;
allowing said user to input a retailer where each respective said product on which said authenticity rating is derived, was purchased;
storing in said digital database, each said retailer in a relation to each said product on which said authenticity rating is derived;
each time a subsequent said authenticity rating is derived from a said comparison, examining a said identification of each subsequent said product with all said purchased products in said digital database, and identifying possible negative interactions between said purchased products;
communicating to said user a warning of a said negative interaction if found; and
communicating a said warning to a respective said retailer identified by said user as the respective said retailer where said respective product was purchased, of said negative interaction.

15. The software enabled product authentication method of claim 13 wherein said products are drugs, additionally comprising:
storing in said digital database, prescriptions issued by medical processionals related to each respective said drug prescribed to each respective said user; and
providing access to an internet accessible seller interface for sellers of said drugs, to request a verification of a respective said prescription as being matched in said digital database to the respective said user attempting a purchase a respective said drug.

16. The software enabled product authentication method of claim 14 wherein said products are drugs, additionally comprising:
storing in said digital database, prescriptions issued by medical processionals related to each respective said drug prescribed to each respective said user; and
providing access to an internet accessible seller interface, for sellers of said drugs, to request a verification of a respective said prescription as being matched in said digital database to the respective said user attempting a purchase a respective said drug.
